(19) United States
(12) Patent Application Publication
(10) Pub. No.: US 2026/0308032 A1
(43) Pub. Date: Oct. 8, 2026

(54) MEDIA FOR USE IN WASTEWATER TREATMENT

(71) Applicant: TECHNOLOGIES BIONEST INC., Shawinigan (CA)

(72) Inventors: Garfield R. LORD, Shawinigan (CA); Alexandre MOREAU, Shawinigan (CA); Etienne BOUTET, Shawinigan (CA); Rejean TROTECHAUD, Shawinigan (CA)

(21) Appl. No.: 19/482,329

(22) PCT Filed: May 9, 2024
(86) PCT No.: PCT/CA2024/050627

§ 371 Date: Nov. 7, 2025

(30) Foreign Application Priority Data
May 9, 2023 (CA) 3199100

(51) Int. Cl. C02F 3/10

(52) U.S. Cl. CPC C02F 3/103; C02F 3/108

(57) ABSTRACT

Media for use in wastewater treatment, the media comprising: a plurality of strand bundles, each strand bundle comprising two or more strands, each strand of a respective strand bundle being elongate and having an undulating configuration with surfaces on which bacteria can grow, and wherein the two or more strands of a given strand bundle are intertwined, and wherein at least some of the strands of the plurality of strand bundles are intertwined to interconnect some of the bundles of strands.

### FIELD OF THE DISCLOSURE

The present disclosure relates to media for use in wastewater treatment, more specifically media for use in wastewater treatment of attached-growth type.

### BACKGROUND OF THE DISCLOSURE

In wastewater treatment, contaminants in wastewater, such as harmful bacteria, nitrogen and phosphorus, are removed or reduced. Many different types of wastewater treatment exist to account for different types of wastewater and contaminants such as industrial, agricultural, municipal and agri-food.

Most wastewater treatments are based on biological treatments in which microorganisms are used to break down solids as well as the contaminants in the wastewater. The microorganisms convert dissolved and particulate organic matter, measured as biochemical oxygen demand (BOD), into cell mass. Wastewater treatments are performed in reactors such as dedicated tanks, or dedicated bodies of water such as lagoons, ponds and lakes, for example.

In biological wastewater processes known as attached bacterial growth or fixed-film wastewater treatments, media is provided in the reactor for the microorganisms to attach to and grow on to form a biofilm. As the biofilm thickens, some of it sloughs off the media and accumulates in the reactor as sludge for subsequent removal. Trickling filters, moving bed biofilm reactors (MBBR) and rotating biological contactors (RBCs) are common types of attached growth wastewater treatment systems.

Different types of media are used in existing attached-growth processes, which include natural and synthetic materials. Natural materials include peat, coconut husks and wood chips but have the disadvantage that they can be “used up” over time. Synthetic materials comprise inert polymeric or ceramic materials.

Examples of media with a fixed position in the reactor comprise plastic blocks made of corrugated sheets forming channels therebetween (e.g. U.S. Pat. No. 6,136,194), hanging textiles (e.g. U.S. Pat. Nos. 6,540,920; 6,110,374), and hanging strips (e.g. U.S. Pat. No. 6,540,920).

Examples of media which can move (“moving media”) in the reactor comprise plastic honeycomb shaped pieces, balls, particles (U.S. Pat. No. 5,618,430), and self-supporting strips (U.S. Pat. No. 7,578,398) which can move about in the wastewater.

A disadvantage of the fixed position media is their tendency to accumulate sludge compared to moving media. In reactors with fixed position media, an aeration system is typically provided and is designed to meet the oxygen demand required for the biological treatment of contaminants. This aeration is typically not sufficient to evacuate the excess sludge from the reactor. In certain reactor types, it has the advantage of not requiring a secondary clarifier after the reactor.

In reactors with moving media, movement of the media either within the reactor or relative to itself encourages sloughing which can control to some extent the biofilm accumulation on the media. In such moving media reactors, there is a second mixing requirement for the aeration to distribute the media in the reactor volume and to control the biofilm thickness. This mixing can also help to evacuate the excess sludge from the reactor, thus requiring a solid-liquid separation such as a secondary clarifier to separate the solids from the clarified effluent.

Sludge accumulation can significantly reduce fluid pathways through the reactor and the media by which subsequent contaminants may contact the microorganisms, thereby leading to a slow down or stopping of the treatment of the wastewater. Sludge accumulation can also increase the oxygen demand in the reactor. It is thus required to increase the oxygen supply to maintain the treatment quality, otherwise the oxygen demand might exceed the oxygen supply and result in a deterioration of the effluent quality. Finally, sludge accumulation can also decrease the oxygen transfer efficiency of the aeration system. The air bubbles will create preferential paths in the accumulated sludge, leading to air bubble coalescence and air bubble size increase. Since the oxygen transfer efficiency is inversely proportional to air bubble size, air bubble coalescence resulting form sludge accumulation will lead to reduced oxygen supply.

When such treatment systems have accumulated a defined sludge quantity, maintenance is required to remove the sludge accumulated in the reactor. Certain maintenance methods include displacing the biofilm on the media using pressurized fluid, and subsequently removing the displaced sludge from the reactor by pumping. Certain other maintenance methods include removal and cleaning of the media, and returning the cleaned media to the reactor.

A further desired property of the media for certain types of wastewater treatment is a distribution of the media through the reactor. A media that is well distributed in the wastewater of the reactor can eliminate the need for, or reduce reliance on, agitators in the reactor for enhancing fluid movement to maximise the treatment efficacy by maximising a bacteria-wastewater contact. This can avoid unnecessary expense and complication to the wastewater system.

However, different types of wastewater that contain different types of contaminants and different loads of contaminants may have different requirements for optimizing treatment efficacy. There is no one size fits all media that can be adapted to suit different BOD and contaminant requirements. Therefore, there is a need for wastewater treatment media which overcomes or reduces at least some of the above-described problems.

### SUMMARY OF THE DISCLOSURE

Certain aspects and embodiments of the present disclosure may overcome or reduce some of the abovementioned problems and disadvantages.

Developers have previously developed media, described in U.S. Pat. No. 7,578,398, which comprises at least one strip that is self supporting and bundled up so as to form a nest-like and loose configuration, the at least one strip presenting a surface for attachment and growth of bacteria, the nest-like and loose configuration being constructed and arranged so that the nest-like and loose configuration allows for the free circulation of the liquid through the attached growth bacteria, the at least one strip having an irregular form that substantially prevents the nest-like configuration from compacting, wherein the at least one strip is made of a non-toxic and non-biodegradable polymeric material.

Advantageously, the media of U.S. Pat. No. 7,578,398 has a configuration which is changeable thanks to the strips being movable relative to each other. The strips are unattached, and can self-distribute when placed into wastewater so that they spread out within the wastewater of the reactor. This can maximise a treatment efficacy by maximising a bacteria-wastewater contact, without relying on agitators to enhance fluid flow.

Furthermore, as the strips of the media of U.S. Pat. No. 7,578,398 can move relative to one another, an accumulation of the thickness of the biofilm on the media can be somewhat maintained or slowed thanks to sloughing of the biofilm from the strips.

Although the strip-based media is versatile and effective, Developers have developed structural improvements to the strip-based media of U.S. Pat. No. 7,578,398 having discovered that such improvements provide enhanced mechanical properties such as break strength and resistance to compression which can contribute to improvements in wastewater treatment efficiencies and economies. More specifically, the enhanced break strength of the media means that during certain maintenance methods involving removal and reinstallation of the media, a structural integrity of the media is maintained. An improved resistance to compression of the media can help to maintain the distribution of the media in the reactor, especially in deep reactors in which accumulated biofilm on the media can cause the media to compress on itself. In certain embodiments, the media of the present technology maintains a break strength and/or compression characteristics whilst presenting an increased surface area for bacteria to attach on and grow.

From a first broad aspect, there is provided media for wastewater treatment which has a configuration that comprises clusters of strands, in which there is strand-strand intertwining within a cluster, as well as strand-strand intertwining between clusters. There may also be twining of the strand with itself. Each strand is discrete, i.e. not permanently fixed to another strand and has two free ends.

According to a first aspect, there is provided media for use in wastewater treatment, the media comprising: a plurality of strand bundles, each strand bundle comprising two or more strands, each strand of a respective strand bundle being elongate and having an undulating configuration with surfaces on which bacteria can grow, and wherein the two or more strands of a given strand bundle are intertwined, and wherein at least some of the strands of the plurality of strand bundles are intertwined to interconnect different bundles of strands. In other words, the at least some of the strands of a given strand bundle has intra-bundle strand intertwining, and the at least some of the strands of different strand bundles have intertwining. A given strand may also be twisted with itself.

In certain embodiments, each strand bundle of the plurality of strand bundles comprises three strands.

In certain embodiments, the undulating configuration of each bundle comprises a series of undulations in the given strand along a length of the strand.

In certain embodiments, at least some of the undulations are convex undulations and at least some of the undulations are concave undulations.

In certain embodiments, each strand has a thickness which is substantially constant along its length.

In certain embodiments, each strand has a transverse cross-section which is rectangular.

In certain embodiments, an extent of the intertwining between the strands of a bundle is more than an extent of the intertwining between the bundles such that strands within a bundle are harder to separate than strands of different bundles.

In certain embodiments, each strand has a transverse cross-section having an area of more than about 0.6 mm².

In certain embodiments, each strand has a width of about 4 mm and a thickness of about 0.2 mm.

In certain embodiments, each strand has a width of about 4 mm and a thickness of about 0.4 mm. In certain embodiments, each strand has a width to thickness ratio of about 20.

In certain embodiments, each strand has a length which is in a range of about 350 m to about 2500 m.

In certain embodiments, each strand has a first surface, a second surface, and two side edges, wherein a length of one of the side edges is longer than a length of the other of the side edges.

In certain embodiments, when the media is free-standing or free-floating (e.g. suspended), spacings between the strands in each bundle are generally smaller than spacings between strands of different bundles.

In certain embodiments, each strand is made of a polymeric material, such as one or more of acrylonitrile butadiene styrene (ABS), polyvinyl chloride (PVC), polypropylene and high density polyethylene (HDPE).

In certain embodiments, a specific surface area of the media is 330 m²/m³ of wastewater.

In certain embodiments, the plurality of strand bundles are configured to be self-supporting in wastewater.

In certain embodiments, the plurality of strand bundles are not twisted together at a single twist point.

From another aspect, there is provided media for use in wastewater treatment, the media comprising a plurality of elongate strands having surfaces on which bacteria can grow, each strand comprising convex undulations and concave undulations and having a width to thickness ratio of about 20.

In certain embodiments, each strand has a width of about 4 mm and a thickness of about 0.4 mm.

In certain embodiments, a specific surface area of the media is 330 m²/m³ of wastewater.

In certain embodiments, the undulating configuration comprises a series of undulations in the given strand along a length of the strand.

In certain embodiments, each strand has a thickness which is substantially constant along its length.

In certain embodiments, each strand has a transverse cross-section which is rectangular.

In certain embodiments, each strand has a transverse cross-section having an area of more than about 0.6 mm².

In certain embodiments, each strand has a length which is in a range of about 350 m to about 2500 m.

In certain embodiments, each strand has a first surface, a second surface, and two side edges, wherein a length of one of the side edges is longer than a length of the other of the side edges.

In certain embodiments, each strand is made of a polymeric material, such as one or more of acrylonitrile butadiene styrene (ABS), polyvinyl chloride (PVC), polypropylene and high density polyethylene (HDPE).

In certain embodiments, the plurality of strand bundles are configured to be self-supporting in wastewater.

In certain embodiments, at least some of the elongate strands have inter-strand intertwining (different strands are intertwined). In certain embodiments, at least some of the elongate strands are intertwined/twisted with themselves.

From a yet further aspect, there is provided media for use in wastewater treatment, the media comprising a plurality of elongate strands having surfaces on which bacteria can grow, each strand comprising convex undulations and concave undulations and having a thickness of about 0.4 mm.

In certain embodiments, the undulating configuration of each bundle comprises a series of undulations in the given strand along a length of the strand.

In certain embodiments, each strand has a thickness which is substantially constant along its length.

In certain embodiments, each strand has a transverse cross-section which is rectangular.

In certain embodiments, each strand has a transverse cross-section having an area of more than about 0.6 mm².

In certain embodiments, each strand has a width to thickness ratio of about 20.

In certain embodiments, each strand has a length which is in a range of about 250 m to about 2500 m.

In certain embodiments, each strand has a first surface, a second surface, and two side edges, wherein a length of one of the side edges is longer than a length of the other of the side edges.

In certain embodiments, each strand is made of a polymeric material, such as one or more of acrylonitrile butadiene styrene (ABS), polyvinyl chloride (PVC), polypropylene and high density polyethylene (HDPE).

In certain embodiments, a specific surface area of the media is 330 m²/m³ of wastewater.

In certain embodiments, the plurality of strand bundles are configured to be self-supporting in wastewater.

In certain embodiments, at least some of the elongate strands have inter-strand intertwining (different strands are intertwined). In certain embodiments, at least some of the elongate strands are intertwined/twisted with themselves.

From a yet further aspect, there is provided a reactor comprising wastewater to be treated and the media according to any of the embodiments described herein.

In certain embodiments, the media is housed in at least one mesh bag.

In certain embodiments, the media is housed in a plurality of mesh bags which are spaced from one another and are distributed in the wastewater in use.

In certain embodiments, the plurality of strand bundles of the media are self-supporting in wastewater.

In certain embodiments, the plurality of strand bundles of the media have a disordered/nest-like configuration.

In certain embodiments, the nest-like configuration extends in three directions (XYZ).

In certain embodiments, the media is configured to be substantially submerged in the wastewater of the reactor.

In certain embodiments, wherein the reactor does not include a support, such as a support bar, for supporting the plurality of strand bundles of the media.

In certain embodiments, at least some of the elongate strands have inter-strand intertwining (different strands are intertwined). In certain embodiments, at least some of the elongate strands are intertwined/twisted with themselves.

In certain instances, embodiments of the media of the present technology improve a resistance to compressibility of the mass of strands when under load (such as when biofilm is attached to the media). This can be helpful when used in reactors which are relatively deep and/or when treating wastewater with higher loads of BOD.

In certain instances, embodiments of the media of the present technology improve a break strength of the strands of the media. This can be helpful during handling of the media, such as during removal or maintenance of a biofilm loaded biomedia.

According to another aspect, there is provided a reactor with the media housed therein according to any of the embodiments described above. In certain embodiments, the reactor comprises a tank, a well, a lagoon or a pond.

### Definitions

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

As used herein, the term “reactor” is to be taken to mean an apparatus or a place in which a biological reaction or process can be carried out to convert dissolved and/or suspended biological matter in wastewater, using microorganisms (e.g. bacteria). Reactors include tanks, wells, lagoons and ponds. The biological reaction includes, but is not limited to, nitrification, denitrification, phosphorus removal and/or carbon removal. The conversion may be aerobic, anaerobic or anoxic. As used herein, the term “media”, also known as a bacteria growth device or biofilm support media, is to be taken to mean any media or device having a surface suitable for bacterial growth and/or attachment.

As used herein, the term “water treatment system” is to be taken to mean a system for cleaning or purifying water such as domestic or industrial wastewater or highly polluted water or polluted water originating from any means.

As used herein, the term “body of water” is to be taken to mean any one or more volume(s) of water which is to be treated. The body of water may be a single body of water, or multiple bodies of water joined together. The body of water may be man-made or natural. The term “body of water” includes ponds, lagoons, basins, tanks, and combinations of the same.

### BRIEF DESCRIPTION OF DRAWINGS

Further aspects and advantages of the present invention will become better understood with reference to the description in association with the following in which:

FIG. 1 illustrates media comprising a plurality of bundles, each bundle comprising three intertwined strands, according to embodiments of the present disclosure;

FIG. 2 illustrates the media of FIG. 1 with a higher density of the media per unit volume, according to embodiments of the present disclosure;

FIG. 3 is a schematic illustration of one bundle of the media of FIG. 1, according to embodiments of the present disclosure;

FIG. 4 is a schematic illustration of one strand of the one bundle of FIG. 3, according to embodiments of the present disclosure;

FIG. 5 illustrates a close-up perspective view of a portion of the one strand of FIG. 4, according to embodiments of the present disclosure;

FIG. 6 is top plan view of the portion of the one strand of FIG. 5, according to embodiments of the present disclosure;

FIG. 7 is a cross-section view through the line A-A′ of FIG. 6, according to embodiments of the present disclosure;

FIG. 8 is a cross-sectional schematic view of a reactor housing the media of FIG. 1, according to embodiments of the present disclosure; and

FIG. 9 is a perspective view of another reactor housing the media of FIG. 1, according to embodiments of the present disclosure.

### DETAILED DESCRIPTION

Although the embodiments of the present technology depicted herein comprise certain geometrical configurations and arrangements, not all of these components, geometries and/or arrangements are essential to the invention and thus should not be taken in their restrictive sense, i.e. should not be taken as to limit the scope of the present invention. It is to be understood, as also apparent to a person skilled in the art, that other suitable components and co-operations thereinbetween, as well as other suitable geometrical configurations and arrangements may be used without departing from the scope of the invention. In the following description, the same numerical references refer to similar elements.

The present invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items.

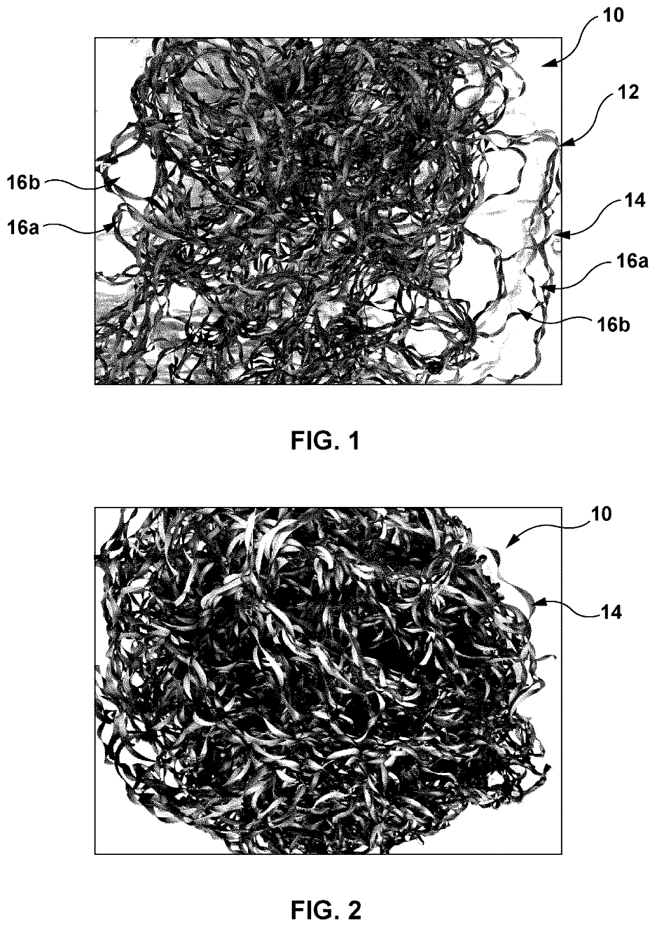

According to a broad aspect, and referring to FIGS. 1 and 2, there is provided media 10 for wastewater treatment on which bacteria can attach and grow. The media 10 comprises a plurality of bundles 12 (also referred to as “clusters 12”) of strands 14. Each bundle 12 has multiple strands 14. Within the media 10 there is intertwining between at least some of the strands 14 of each bundle 12 (“intra-bundle strand intertwining) as well as intertwining between at least some of the strands 14 of different strand bundles 12 (“inter-bundle strand intertwining). Intra-bundle strand intertwining also includes twining of a given strand with itself. The media therefore comprises media 10 having a tangled mass of strands 14 with spaces 16a, 16b in between for wastewater to flow. Due at least in part to the bundling of the strands 14, the spaces 16a between the strands 14 of each bundle 12 are generally smaller than the spaces 16b between strands 14 of different bundles 12. This can provide an improved fluid flow and hence contribute to treatment efficiency, in certain embodiments. The interconnectivity between the strands 14 within and between the bundles 12 can also help to keep the media 10 together during installation and removal from a reactor which can make those processes more efficient. Furthermore, and with reference to Example 1 below, it was demonstrated that clustering strands 14 as bundles 12 in the media 10 significantly increases an average break strength, compared to media comprising non-bundled strands of equivalent mass.

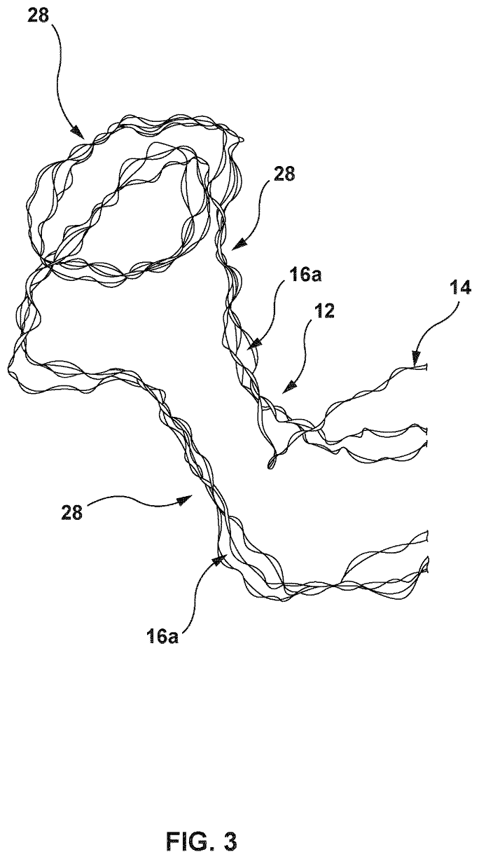

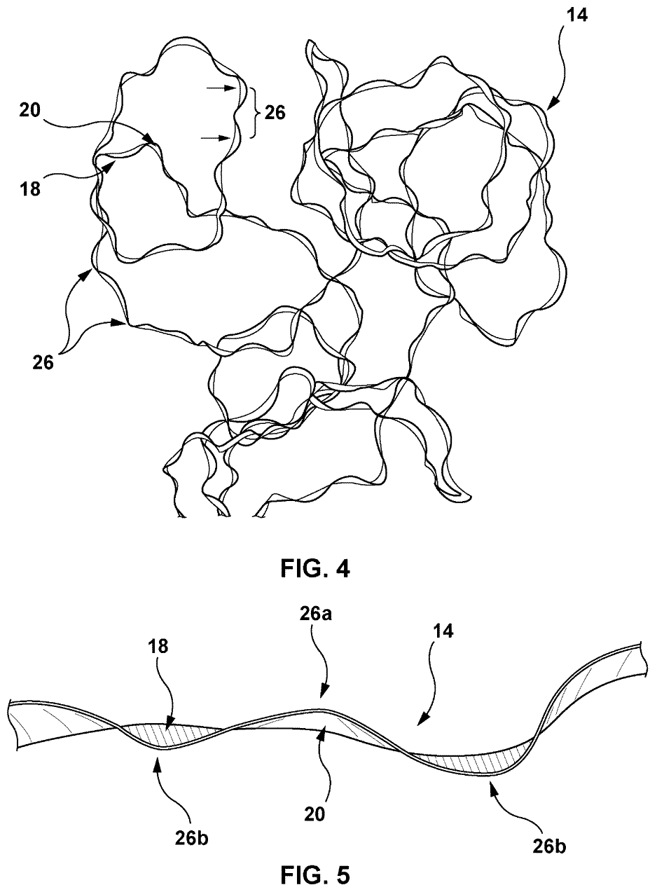

An isolated bundle 12 of the strands 14 from the media 10 of FIGS. 1 and 2 is shown in FIG. 3, and an isolated strand 14 from a bundle 12 is shown in FIG. 4.

As best seen in FIG. 3, the bundle 12 of strands 14 comprises three strands 14 intertwined with one another. There are at least two strands 14 in a bundle 12, but the number of strands 14 is not particularly limited. For example, there may be provided two strands 14, three strands 14, four strands 14 or five strands 14 in the bundle 12. In certain embodiments, the media 10 comprises bundles 12 of strands 14 having the same number of strands 14. In other embodiments, the media comprises bundles 12 of strands 14 having different number of strands 14.

Referring now to FIGS. 3 to 5, each strand 14 of the bundle 12 comprises an elongate undulating (wavy) strip with surfaces on which bacteria can grow. As best seen in FIGS. 5 and 7, the surfaces include a first surface 18, a second surface 20, a third surface 22 and a fourth surface 24. It will be appreciated that the strand 14 is ribbon-like, with a width of the surfaces 18, 20 being wider than a width of the third and fourth surfaces 22, 24. The third and fourth surfaces 22, 24 are also referred to herein as side edges 22, 24. The first and second surfaces 18, 20 are oppositely facing one another, and the third and fourth surfaces 22, 24 are oppositely facing one another and substantially transverse to the first and second surfaces 18, 20.

Referring to FIGS. 3, 4 and 5, each strand 14 is discrete, i.e. not permanently fixed to another strand, and has two free ends. In certain embodiments, a length of one of the side edges 22, 24 is longer than a length of the other of the side edges 22, 24 as a result of, or giving rise to the undulations.

Each strand 14 has undulations 26 along its length. The undulations 26 are spaced from one another, in series, along each strand 14. In certain embodiments, the undulations 26 are spaced at regular intervals from one another. In other embodiments, the undulations 26 are irregularly spaced. A given strand 14 may also have some undulations 26 which are regularly spaced and other undulations 26 which are irregularly spaced.

A number of undulations 26 on each strand 14 is not particularly limited and is dependent on the length of the strand. In certain embodiments, there are more than about 50,000 undulations, more than about 60,000 undulations, more than about 70,000 undulations, or more than about 80,000 undulations on a given strand 14. In certain embodiments, there are about 85,000 undulations per strand 14.

The undulations 26 of each strand 14 comprise convex undulations 26a as well as concave undulations 26b visible as peaks and troughs 26a, 26b, respectively. The convex and concave undulations 26a, 26b are also referred to as positive and negative waves 26a, 26b. In certain embodiments, the convex and concave undulations 26a, 26b are alternated along the length of the strand 14. In other embodiments, the undulations 26 comprise concave undulations 26a only, or concave undulations 26b only.

A spacing of the undulations 26 from each other is not particularly limited. In certain embodiments, the spacing (best seen in FIG. 5) of the undulations 26b-26b is between about 2 and 3 cm, for example 2.5 cm.

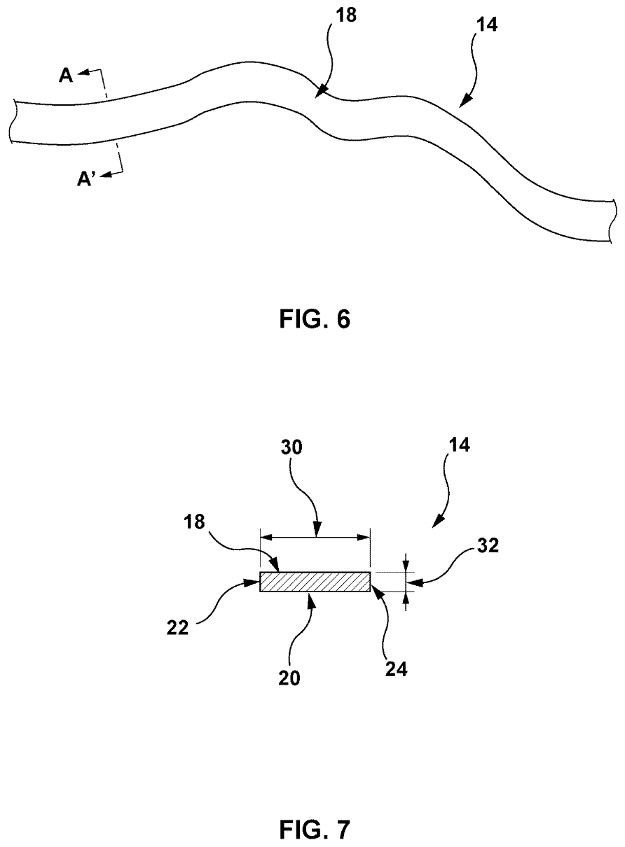

As best seen in FIG. 6, which is an example top plan view of a single strand 14, the undulations 26 provide each strand 14 with an overall irregular configuration. Each strand 14 is non-planar in 3D space. In other words, each strand 14 has a configuration which bends and twists in different directions along its length. The two free ends of each strand 14 do not lie on a same plane. It has been found by the Developers that this configuration can help with the intertwining between the strands 14 of a given bundle 12.

Referring now to the intertwining between the strands 14 of each bundle 12, the intertwining comprises a criss-crossing of two or more of the strands 14 in each bundle 12. At least some of the strands 14 may also criss-cross themselves. In some embodiments, the intertwining resembles helical entanglements, such as of the type seen in DNA strands. In other embodiments, the intertwining is less ordered and comprises a criss-crossing or a twisting between strands 14 at one or more locations.

The intra-bundle strand intertwining is different than the inter-bundle strand intertwining. Generally, the intra-bundle strand intertwining makes the strands 14 within the respective bundle 12 harder to separate from each other than strands 14 between the bundles 12. The intra-bundle strand intertwining comprises a twisting together of at least some of the strands 14 of at least some of the bundles 12. Not all the bundles 12 are interconnected with all other bundles 12. In contrast, each strand 14 of each bundle 12 is interconnected with the other strands 14 of the given bundle 12 in inter-bundle strand intertwining.

It will be appreciated that the strands 14 of a bundle 12 are not twisted together at a single twist point. As best seen in FIG. 3, in each bundle 12, the strands 14 may have numerous points of criss-crossing 28 along the length of the respective strands. This provides media having a nest-like, disordered arrangement of strands 14. The media 10 has a three-dimensional structure extending in X-Y-Z directions. The media 10 does not have a linear, draped configuration.

The media 10 is thus configured to be self supporting and does not require support structures in the reactor. This is unlike that of percolating filters such as in U.S. Pat. No. 4,451,362 in which strips are combined together at a single twist point and the strips supported by a support bar at the twist point. In such prior art systems, the percolating filters are configured to hang downwardly.

The media 10 is made from a polymeric material such as acrylonitrile butadiene styrene (ABS), polyvinyl chloride (PVC), high-density polyethylene, polypropylene or any other polymer that can be heated, extruded, molded, milled, cast and/or made in a way that will allow forming the strands 14 with the undulations. Each strand 14 is made of a material having a density of within the range: 0.9-1.55 g cm⁻³ and can thus be suspended yet submerged in the wastewater.

In certain embodiments, a length of each strand 14 is at least 400 m. In certain embodiments, the length of each strand 14 is about 500 m, about 600 m, about 700 m, about 800 m, about 900 m, about 1000 m, about 1200 m, about 1400 m, about 1600 m, about 1800 m, about 2000 m. In certain embodiments, the media 10 comprises bundles 12 of strands 14 having the same length. In other embodiments, the media 10 comprises bundles 12 of strands 14 having different lengths. As mentioned earlier, the two edges 22, 24 of a given strand 14 have different lengths. These are true lengths. The length of the strand 14 is a measure of the distance between the two free ends when taken at a mid point between the two edges 22, 24, and when the strand 14 is at rest on a support surface.

Referring to FIG. 7, each strand 14 has a transverse cross-sectional shape which is rectangular. Although not illustrated, other transverse cross-sectional shapes are also within the scope of the present technology such as circular, square, trapezoidal, oval. Although the surfaces 18, 20, 22, 24 are depicted as being flat, they may also have other configurations such as discontinuous, porous, indented, patterned, and the like.

In certain embodiments, a width 30 of each strand 14 is at least 3.5 mm. In certain embodiments, the width 30 of each strand 14 is about 4.0 mm, about 4.5 mm, or about 5.0 mm. In certain embodiments, the media 10 comprises bundles 12 of strands 14 having the same width 30. In other embodiments, the media 10 comprises bundles 12 of strands 14 having different widths 30.

In the illustrated embodiment, a thickness 32 of the strand 14 is substantially constant along its length. However, in other embodiments, the thickness 32 may be variable. For example, the strand 14 may be thinner at a peak and trough of a respective undulation 26. The width 30 of the strand 14 is greater than the thickness 32 of the strand 14.

In certain embodiments, the thickness 32 of each strand 14 is at least 0.2 mm. In certain embodiments, the thickness 32 of each strand is about 0.2 mm, about 0.3 mm, about 0.4 mm, or about 0.5 mm. In certain embodiments, the media 10 comprises bundles 12 of strands 14 having the same thickness 32. In other embodiments, the media 10 comprises bundles 12 of strands 14 having different thicknesses 32. The width 30 of a given strand 14 is greater than the thickness 32 of the given strand 14.

In certain embodiments, a ratio of the width 30 to the thickness 32 of the strand 14 is 10, 15 or 20. In embodiments where the ratio is 20, the strand 14 may have any one of the respective width 30 and thicknesses 32:about 4 mm width and about 0.2 mm thickness; about 5 mm width and about 0.25 mm thickness, and about 6 mm width and about 0.3 mm thickness. The ratio of the width:thickness of each strand 14 reflects its ribbon-like nature and exploits a surface area:mass ratio which is advantageous for supporting bacterial growth.

In certain embodiments, a transverse cross-section area of each strand 14 is about 0.8 mm² or about 1.6 mm².

Developers have also discovered that adapting various dimensions of the strands 14 making up the media can provide the media 10 with overall differing properties. These dimensional relationships are seen in both bundled configuration media 10 and non-bundled configuration media of the strand type. For example, Developers have discovered that doubling the thickness 32 of the strand 14 whilst maintaining a specific surface area of the media 10, more than doubles a resistance of the media 10 to compressibility (Example 3). Increasing the thickness 32 also improves the break strength of the strands 14 (Example 4).

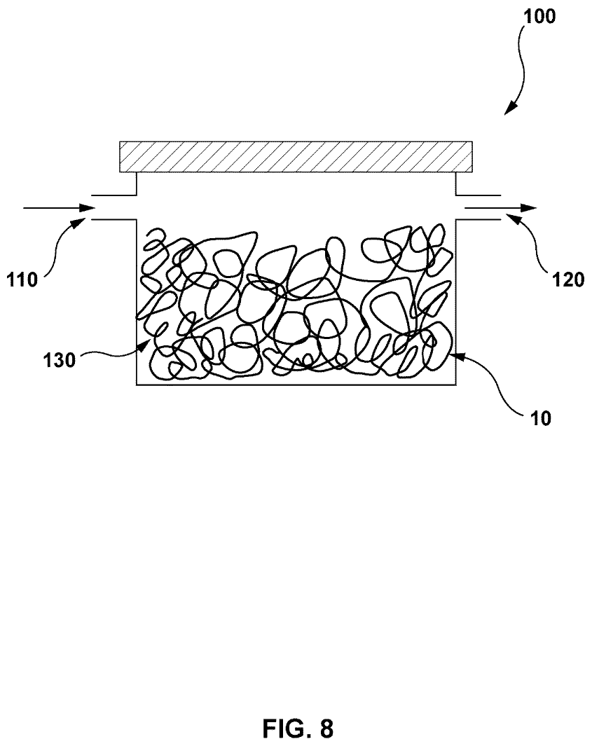

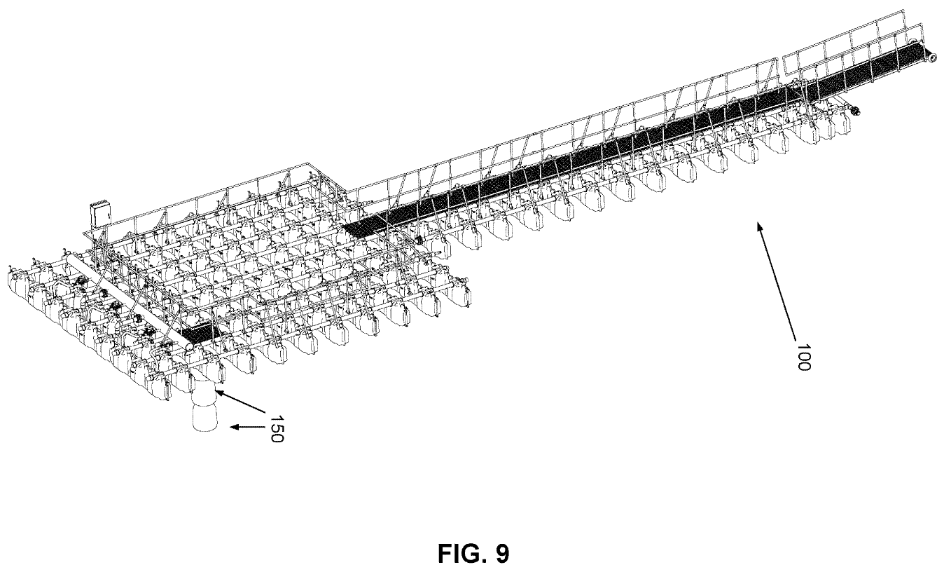

According to other aspects of the present technology, and referring to FIGS. 8 and 9, there is provided reactors 100 housing the media 10 therein. The reactor 100 comprises an inlet 110 and an outlet 120. The media 10 distributes itself within wastewater 130 in the reactor 100 so that it is generally evenly distributed throughout the wastewater 130.

The media 10 can be provided at any suitable density relative to the volume of the wastewater 130.

An amount of the media 10 in the wastewater 130 may be more than 80 m²/m³ of wastewater. In certain embodiments, the surface area of the media 10 per volume of wastewater comprises 80 m²/m³ to 330 m²/m³. In certain embodiments, the media 10 comprises 165 m² surface area of media per m³ of wastewater. In certain embodiments, the media 10 occupies a volume in one reactor of about 1.0% up to 5.0%, between about 1.0% to about 3.0%, between about 1.3% and 4%, or between about 1.5% and about 3.5%.

In certain embodiments, such as the reactor 100 shown in FIG. 9, the media 10 may be provided in porous bags 150 which are removably attached to each other and/or the reactor 100. The reactor may comprise any configuration such as the reactor described in U.S. Pat. No. 10,570,040 B2, the contents of which are herein incorporated by reference.

The following examples are illustrative of the wide range of applicability of the present technology and is not intended to limit its scope. Modifications and variations can be made therein without departing from the spirit and scope of the invention.

### EXAMPLES

### Example 1: Media Comprising Bundles of Strands Vs. No Bundles

Media 10 comprising bundles 12 of strands 14 with intra-bundle and inter-bundle intertwining according to embodiments of the present technology was compared with media comprising plurality of strands without the bundles. It was found that the media 10 comprising the bundles 12 of the strands 14 has improved properties over media comprising single strands, as demonstrated below. Each strand had the same thickness (0.2 mm) and width (4 mm).

| | | Bundles of strands |
|---|---|---|
| | | (three strands |
| | Single | per strand |
| | strands | bundle) |
| Compressibility (%) | 34.50 | 34.50 |
| Average break strength (N) | 17.64 | 59.83 |

The media comprising bundles of strands has a higher average break strength than media comprising single strands. Compressibility is not compromised.

### Example 2: Adjusting Strand Thickness (0.2 mm Vs 0.4 mm Thick Strands) in Bundles

Media 10 comprising the bundles 12 of the strands 14 having thicknesses of 0.2 mm and 0.4 mm, according to embodiments of the present technology, were compared. It was found that the media 10 having thicker strands (0.4 mm) has improved average break strength over media having less thick strands (0.2 mm).

Media comprising strand bundles (three strands per strand bundle)

| | Each strand: | Each strand: |
|---|---|---|
| | 4 mm wide × | 4 mm wide × |
| | 0.2 mm thick | 0.4 mm thick |
| Average break | 59.83 | 85.41 |
| strength (N) | | |

Compressibility is improved in the bundles when thickness of each strand is increased. Average break strength is improved when thickness of each strand in a bundle is increased.

### Example 3: Strand Bundles, Maintaining Specific Surface Area and Increasing Thickness of Each Strand

Media 10 comprising the bundles 12 of the strands 14 having thicknesses of 0.2 mm and 0.4 mm, according to embodiments of the present technology, were compared. It was found that the media 10 having thicker strands (0.4 mm) had significantly improved compressibility (when comparing equivalent specific surface areas of media, with the mass of the 0.4 mm thick media having a mass which is about double the mass of the 0.2 mm thick media).

Media comprising strand bundles (three strands per strand bundle)

| | Each strand: | Each strand: |
|---|---|---|
| | 4 mm wide × | 4 mm wide × |
| | 0.2 mm thick | 0.4 mm thick |
| Compressibility (%) | 35.71 | 14.10 |
| (Specific surface area is | | |
| the same for both groups) | | |

### Example 4: Single Strands, 0.2 mm Vs 0.4 mm Thick Strands

Single strands 14 having thicknesses of 0.2 mm and 0.4 mm were compared. It was found that the media 10 having thicker strands (0.4 mm) had significantly improved average break strength compared to the thinner strands.

Single strand

| | Each strand: | Each strand: |
|---|---|---|
| | 4 mm wide × | 4 mm wide × |
| | 0.2 mm thick, ABS | 0.4 mm thick, ABS |
| Average break | 17.64 | 36.24 |
| strength (N) | | |

### Example 5: Compressibility Test

A container having internal dimensions of 711 mm×711 mm×711 mm was obtained. The given volume of the container represents a specified volume that the media 10 would occupy in a reactor. The container comprised a cover that can move up and down using a vertical guiding rail. To test for compressibility of the media, the media was placed inside the container and the cover was placed on top. Load was applied to the lid to compress the media (25.4 kg). A height of the cover from a base of the container was measured before and after the application of the load.

### Example 6: Average Break Strength

A strand of the media is held securely by two jaws. One jaw is moved away from the other jaw until breaking point. The force required to break the strand is measured.

The media, method of use and wastewater treatments in which it is used can be applied to treating wastewater discharged from residential, commercial or community wastewater systems, as well as any liquid containing impurities in the present or in any other technical fields, such as industrial or agri-food wastewater. For this reason, “wastewater”, should not be taken to limit the scope of the present invention and should be taken to include all other kinds of liquids or technical applications with which the present invention may be used and could be useful. Furthermore, the reactor of the present disclosure is not limited to use within a reactor as described in relation to FIGS. 8 and 9. Embodiments of the media of the present disclosure can be used in any suitable water treatment chain, system or method.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

For example, it will be appreciated that the media can be used in any other suitable wastewater treatment reactor or system. All references cited herein are incorporated by reference in their entirety and made part of this application.

It should be appreciated that the invention is not limited to the particular embodiments described and illustrated herein but includes all modifications and variations falling within the scope of the invention as defined in the appended claims.

1. Media for use in wastewater treatment, the media comprising:
a plurality of strand bundles,
each strand bundle comprising two or more strands,
each strand of a respective strand bundle being elongate and having an undulating configuration with surfaces on which bacteria can grow, and
wherein the two or more strands of a given strand bundle are intertwined, and
wherein at least some of the strands of the plurality of strand bundles are intertwined to interconnect at least some of the bundles of strands.

2. The media of claim 1, wherein each strand bundle of the plurality of strand bundles comprises three strands.

3. The media of claim 1, wherein the undulating configuration of each bundle comprises a series of undulations in the given strand along a length of the strand.

4. The media of claim 3, wherein at least some of the undulations are convex undulations and at least some of the undulations are concave undulations.

5. The media of claim 1, wherein each strand has a thickness which is substantially constant along its length.

6. The media of claim 1, wherein each strand has a transverse cross-section which is rectangular.

7. The media of claim 1, wherein an extent of the intertwining between the strands of a bundle is more than an extent of the intertwining between the bundles such that strands within a bundle are harder to separate from each other than strands of different bundles from each other.

8. The media of claim 1, wherein each strand has a transverse cross-section having an area of more than about 0.6 mm².

9. The media of claim 1, wherein each strand has a width of about 4 mm and a thickness of about 0.2 mm.

10. The media of claim 1, wherein each strand has a width of about 4 mm and a thickness of about 0.4 mm.

11. The media of claim 1, wherein each strand has a width to thickness ratio of 20.

12. The media of claim 1, wherein each strand has a length which is in a range of about 350 m to about 2500 m.

13. The media of claim 1, wherein each strand has a first face, a second face and two side edges, and wherein a length of one of the side edges is longer than an edge of the other of the side edges.

14. The media of claim 1, wherein when the media is suspended in wastewater, spacings between the strands in each bundle are generally smaller than spacings between strands of different bundles.

15. The media of claim 1, wherein each strand is made of a polymeric material, such as one or more of acrylonitrile butadiene styrene (ABS), polyvinyl chloride (PVC), polypropylene and high density polyethylene (HDPE).

16. Media for use in wastewater treatment, the media comprising a plurality of elongate strands having surfaces on which bacteria can grow, each strand comprising convex undulations and concave undulations and having a width to thickness ratio of about 20.

17. (canceled)

18. The media of claim 16, wherein each strand has a first face, a second face and two side edges, and wherein a length of one of the side edges is longer than an edge of the other of the side edges.

19. (canceled)

20. Media for use in wastewater treatment, the media comprising a plurality of elongate strands having surfaces on which bacteria can grow, each strand comprising convex undulations and concave undulations and having a thickness of about 0.4 mm.

21. (canceled)

22. The media of claim 20, wherein each strand has a first face, a second face and two side edges, and wherein a length of one of the side edges is longer than an edge of the other of the side edges.

23. (canceled)
